(19) United States
(12) Patent Application Publication
(10) Pub. No.: US 2025/0324222 A1
(43) Pub. Date: Oct. 16, 2025

(54) ACCOMMODATION FOR SIDELINK POSITIONING IN CHANNEL LOAD MANAGEMENT

(71) Applicant: QUALCOMM Incorporated, San Diego, CA (US)

(72) Inventors: Mukesh KUMAR, Hyderabad (IN); Srinivas YERRAMALLI, San Diego, CA (US); Alexandros MANOLAKOS, Athens (GR)

(21) Appl. No.: 18/866,668

(22) PCT Filed: May 22, 2023
(86) PCT No.: PCT/US2023/023147

§ 371 Date: Nov. 18, 2024

(30) Foreign Application Priority Data
Jul. 20, 2022 (GR) 20220100580

(51) Int. Cl. H04W 4/029; H04L 27/26; H04W 72/25

(52) U.S. Cl. CPC H04W 4/029; H04L 27/26025; H04W 72/25

(57) ABSTRACT

Techniques for accommodating for sidelink positioning in channel load management are disclosed. The techniques can include transmitting a message indicating a sidelink positioning reference signal (SL-PRS) congestion control processing capability of the UE, determining, in accordance with the SL-PRS congestion control processing capability of the UE, an applicable congestion control processing time value for congestion control of a first sidelink (SL) resource pool, the first SL resource pool comprising SL-PRS resources, measuring a channel busy ratio (CBR) of the first SL resource pool for a first slot, selecting, based on the measured CBR, a resource of the first SL resource pool for use to communicate during a second slot, wherein the second slot is offset in time from the first slot by the applicable congestion control processing time value, and communicating using the selected resource during the second slot.

### RELATED APPLICATIONS

This application claims the benefit of Greek application No. 20220100580, filed Jul. 20, 2022, entitled “ACCOMMODATION FOR SIDELINK POSITIONING IN CHANNEL LOAD MANAGEMENT”, which is assigned to the assignee hereof, and incorporated herein in its entirety by reference.

### BACKGROUND

### Field of Disclosure

The present disclosure relates generally to the field of wireless communications, and more specifically to determining the location of a User Equipment (UE) using radio frequency (RF) signals.

### Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (also referred to herein as “SL”).

### BRIEF SUMMARY

Aspects herein provide for improved congestion control for sidelink sub-channels of radio access networks. According to techniques herein, UEs can be configured to recognize/implement distinct congestion control processing times for sidelink (SL) sub-channels that comprise sidelink positioning reference signal (SL-PRS) resources. This can allow the UEs to better adapt their usage of such SL sub-channels to the levels of congestion thereon.

An example method of wireless communication by a user equipment (UE), according to this disclosure, may comprise transmitting a message indicating a sidelink positioning reference signal (SL-PRS) congestion control processing capability of the UE. The method may also comprise determining, in accordance with the SL-PRS congestion control processing capability of the UE, an applicable congestion control processing time value for congestion control of a first sidelink (SL) resource pool, the first SL resource pool comprising SL-PRS resources. The method may additionally comprise measuring a channel busy ratio (CBR) of the first SL resource pool for a first slot, and selecting, based on the measured CBR, a resource of the first SL resource pool for use to communicate during a second slot, wherein the second slot is offset in time from the first slot by the applicable congestion control processing time value. The method may further comprise communicating using the selected resource during the second slot.

An example user equipment (UE), according to this disclosure, may comprise a transceiver, a memory, and one or more processors communicatively coupled with the transceiver and the memory. The one or more processors may be configured to transmit, via the transceiver, a message indicating a sidelink positioning reference signal (SL-PRS) congestion control processing capability of the UE. The one or more processors may also be configured to determine, in accordance with the SL-PRS congestion control processing capability of the UE, an applicable congestion control processing time value for congestion control of a first sidelink (SL) resource pool, the first SL resource pool comprising SL-PRS resources. The one or more processors may additionally be configured to measure a channel busy ratio (CBR) of the first SL resource pool for a first slot and select, based on the measured CBR, a resource of the first SL resource pool for use to communicate during a second slot, wherein the second slot is offset in time from the first slot by the applicable congestion control processing time value. The one or more processors may further be configured to communicate using the selected resource during the second slot.

An example apparatus for wireless communication, according to this disclosure, may comprise means for means for transmitting a message indicating a sidelink positioning reference signal (SL-PRS) congestion control processing capability of a user equipment (UE). The apparatus may also comprise means for determining, in accordance with the SL-PRS congestion control processing capability of the UE, an applicable congestion control processing time value for congestion control of a first sidelink (SL) resource pool, the first SL resource pool comprising SL-PRS resources. The apparatus may additionally comprise means for measuring a channel busy ratio (CBR) of the first SL resource pool for a first slot and selecting, based on the measured CBR, a resource of the first SL resource pool for use to communicate during a second slot, wherein the second slot is offset in time from the first slot by the applicable congestion control processing time value. The apparatus may further comprise means for communicating using the selected resource during the second slot.

An example non-transitory computer-readable medium, according to this disclosure, may store instructions for wireless communication by a user equipment (UE), the instructions comprising code for transmitting a message indicating a sidelink positioning reference signal (SL-PRS) congestion control processing capability of the UE. The instructions may also comprise code for determining, in accordance with the SL-PRS congestion control processing capability of the UE, an applicable congestion control processing time value for congestion control of a first sidelink (SL) resource pool, the first SL resource pool comprising SL-PRS resources. The instructions may additionally comprise code for measuring a channel busy ratio (CBR) of the first SL resource pool for a first slot and selecting, based on the measured CBR, a resource of the first SL resource pool for use to communicate during a second slot, wherein the second slot is offset in time from the first slot by the applicable congestion control processing time value. The instructions may further comprise code for communicating using the selected resource during the second slot.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to aspects of the disclosure.

FIG. 2 is a diagram of a 5th Generation (5G) New Radio (NR) positioning system, illustrating an example of a positioning system (e.g., the positioning system of FIG. 1) implemented within a 5G NR communication network.

FIGS. 3A-3C are simplified diagrams of scenarios in which sidelink positioning may be used to determine the position of a target user equipment (UE).

FIG. 4 is a diagram showing an example of a frame structure for NR and associated terminology.

FIG. 5 is a diagram showing an example of a radio frame sequence with Positioning Reference Signal (PRS) positioning occasions.

FIG. 6 is a diagram showing example combination (comb) structures, illustrating how RF signals may utilize different sets of resource elements, according to aspects of the disclosure.

FIG. 7 is a diagram illustrating an example resource pool for positioning within a sidelink resource pool, according to aspects of the disclosure.

FIG. 8 is a block diagram illustrating an example operating environment, according to aspects of the disclosure.

FIG. 9 is a flow diagram of an example method for wireless communication by a UE, according to aspects of the disclosure.

FIG. 10 is a block diagram of an embodiment of a UE, which can be utilized in implementations as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

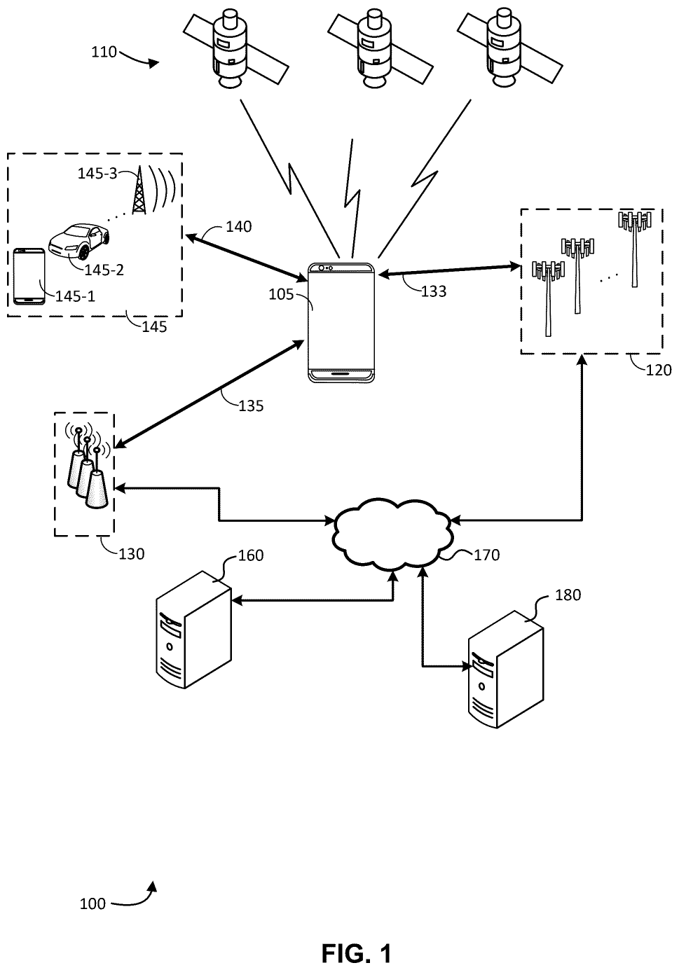

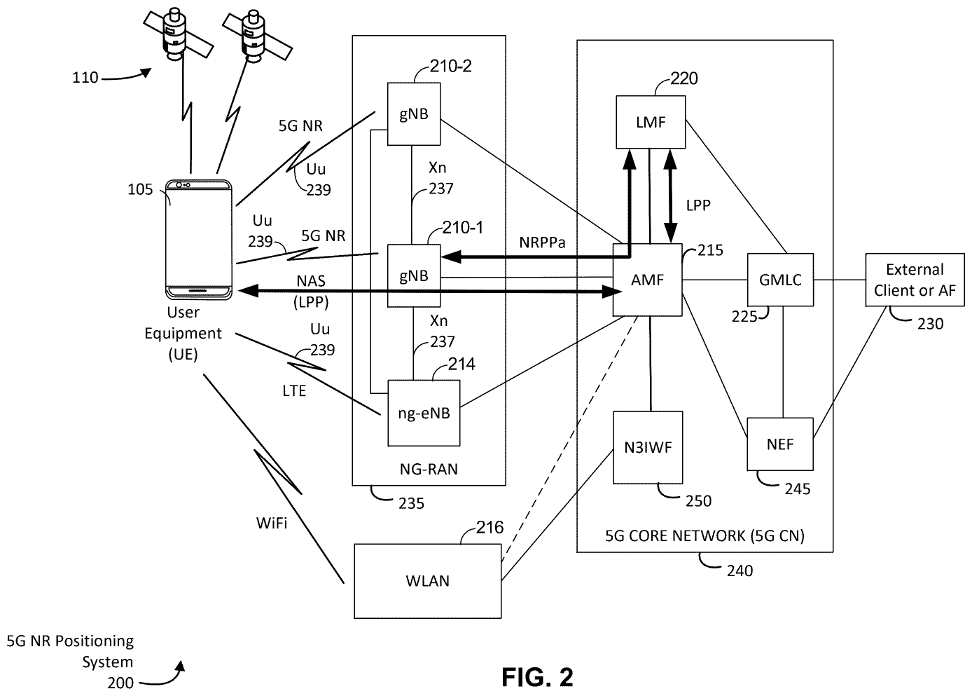

FIG. 1 is a simplified illustration of a positioning system 100 in which a UE 105, location server 160, and/or other components of the positioning system 100 can use the techniques provided herein (and other positioning techniques) for positioning the UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station” in reference to physical transmission points (e.g., for UE positioning). In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When one or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

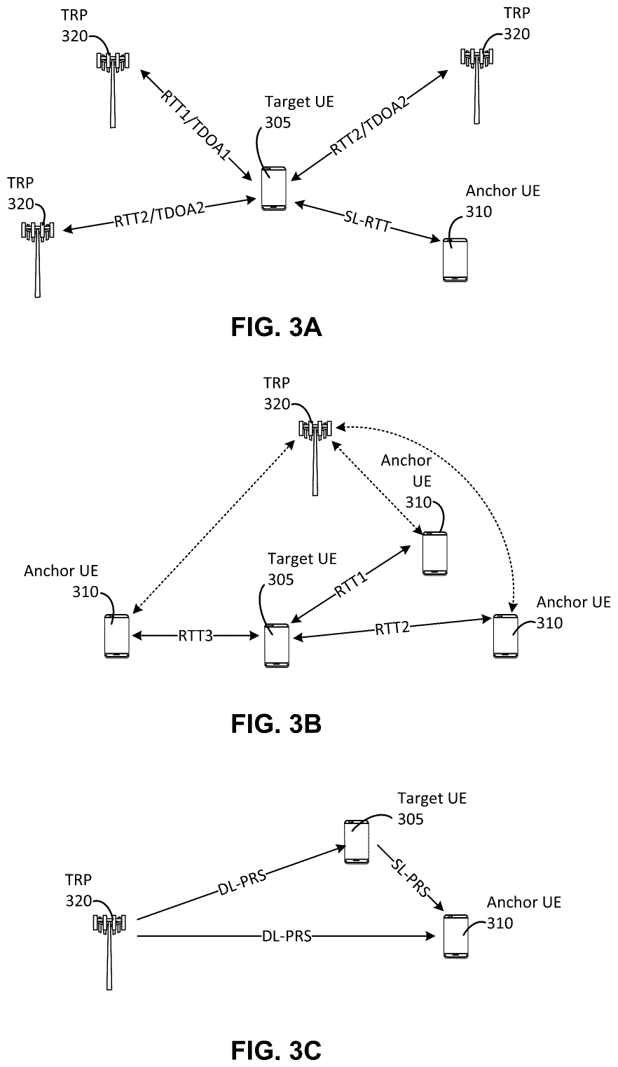

FIGS. 3A-3C are simplified diagrams of scenarios in which sidelink positioning may be used to determine the position of a target UE 305 (e.g., within the systems shown in FIGS. 1 and 2), according to some embodiments. In FIGS. 3A-3C, one or more anchor UEs 310 may be used to send and/or receive reference signals via sidelink. As illustrated, positioning may be further determined using one or more TRPs 320 (base stations) via respective Uu interfaces. It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three TRPs 320. In this configuration, the target UE 305 may be in coverage range for DL and/or UL signals via Uu connections with the TRPs 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may sidelink only (SL-only) positioning/ranging. In this configuration, the target UE 305 may perform RTT measurements via sidelink connections between a plurality of anchor UEs 310. In this example, the target UE 305 may not be in UL coverage of the TRP 320, and therefore each anchor UE 310 may report RTT measurement information to the network of via a Uu connection between each anchor UE 310 and the TRP 320. (In cases in which a UE relays information between a remote UE and a TRP, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the TRP 320, the target UE 305 may report RTT measurements directly to the TRP 320. In some embodiments, no TRP 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the TRP 320, and the target UE 305 sending a reference signal (SL-PRS) to the anchor UE 310. The positioning of the target UE can be determined based on known positions of the TRP 320 and anchor UE 310 and a time difference between a time at which the anchor UE 310 receives the reference signal from the TRP 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize RP-P. RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a TRP (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR). According to some embodiments, exceptional RP-P can be designated and used in circumstances in which it may not be desirable or possible to perform sidelink positioning via the available resource pools of standard RP-P for sidelink.

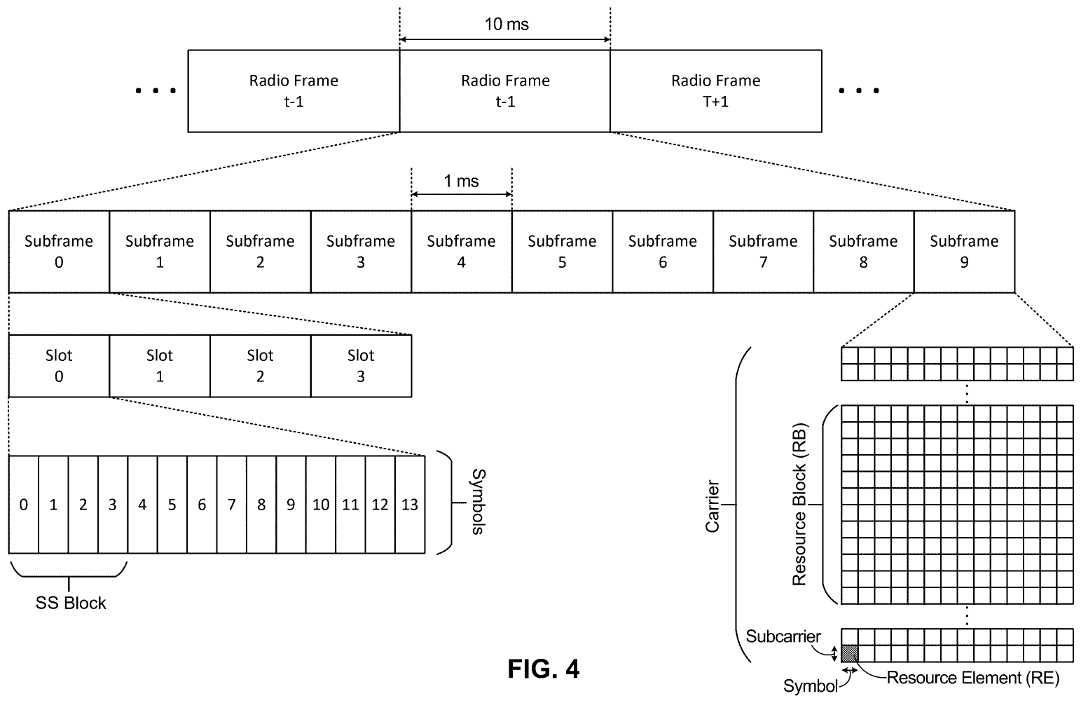

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

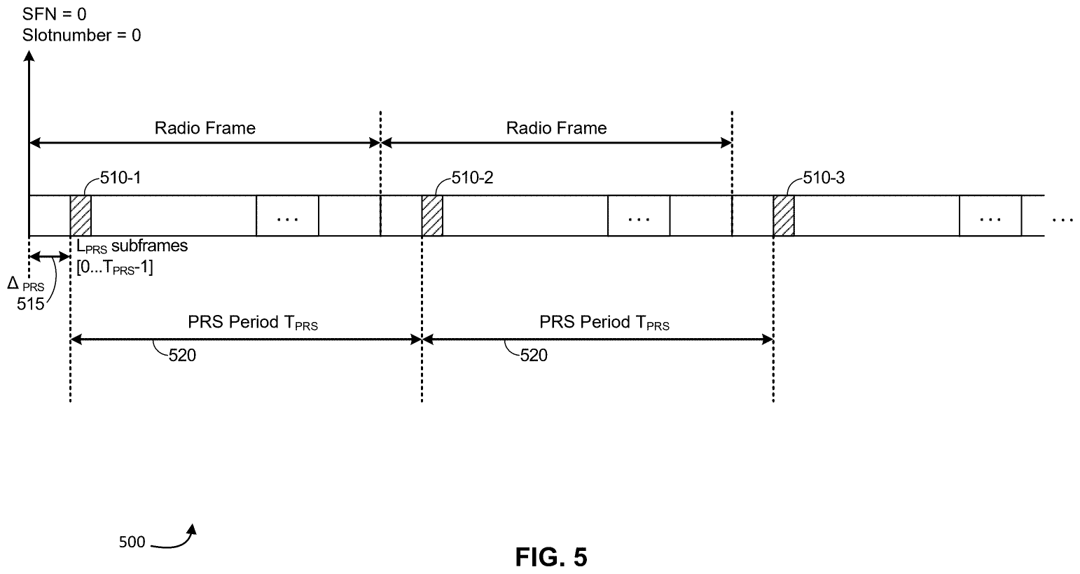

FIG. 5 is a diagram showing an example of a radio frame sequence 500 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.” Subframe sequence 500 may be applicable to broadcast of PRS signals (DL-PRS signals) from base stations 120 in positioning system 100. The radio frame sequence 500 may be used in 5G NR (e.g., in 5G NR positioning system 200) and/or in LTE. Similar to FIG. 4, time is represented horizontally (e.g., on an X axis) in FIG. 5, with time increasing from left to right. Frequency is represented vertically (e.g., on a Y axis) with frequency increasing (or decreasing) from bottom to top.

FIG. 5 shows how PRS positioning occasions 510-1, 510-2, and 510-3 (collectively and generically referred to herein as positioning occasions 510) are determined by a System Frame Number (SFN), a cell-specific subframe offset (APRS) 515, a length or span of LPRS subframes, and the PRS Periodicity (TPRS) 520. The cell-specific PRS subframe configuration may be defined by a “PRS Configuration Index,” IPRS, included in assistance data (e.g., TDOA assistance data), which may be defined by governing 3GPP standards. The cell-specific subframe offset (APRS) 515 may be defined in terms of the number of subframes transmitted starting from System Frame Number (SFN) 0 to the start of the first (subsequent) PRS positioning occasion.

A PRS may be transmitted by wireless nodes (e.g., base stations 120) after appropriate configuration (e.g., by an Operations and Maintenance (O&M) server). A PRS may be transmitted in special positioning subframes or slots that are grouped into positioning occasions 510. For example, a PRS positioning occasion 510-1 can comprise a number NPRS of consecutive positioning subframes where the number NPRS may be between 1 and 160 (e.g., may include the values 1, 2, 4 and 6 as well as other values). PRS occasions 510 may be grouped into one or more PRS occasion groups. As noted, PRS positioning occasions 510 may occur periodically at intervals, denoted by a number TPRS, of millisecond (or subframe) intervals where TPRS may equal 5, 10, 20, 40, 80, 160, 320, 640, or 1280 (or any other appropriate value). In some embodiments, TPRS may be measured in terms of the number of subframes between the start of consecutive positioning occasions.

In some embodiments, when a UE 105 receives a PRS configuration index IPRS in the assistance data for a particular cell (e.g., base station), the UE 105 may determine the PRS periodicity TPRS 520 and cell-specific subframe offset (APRS) 515 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (APRS) 515) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that PRS occasions align in time. A UE 105 may determine the timing of the PRS occasions 510 of the reference and neighbor cells for TDOA positioning, if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

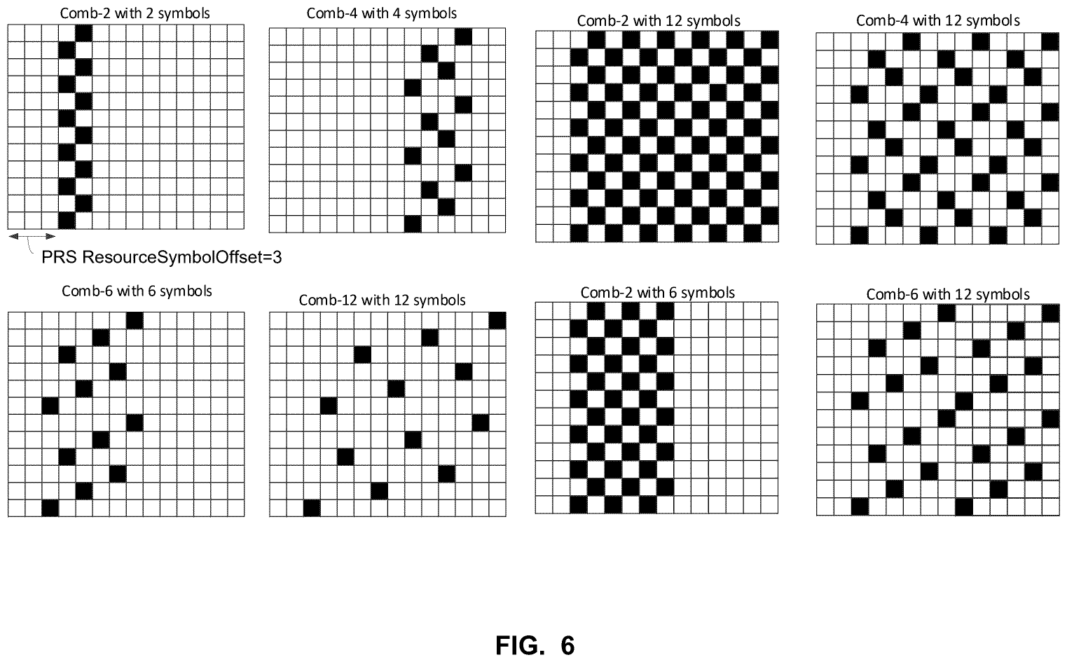

With reference to the frame structure in FIG. 4, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS. Examples of different comb sizes using with different numbers of symbols are provided in FIG. 6.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (gNB 210, ng-eNB 214, and/or WLAN 216) may transmit frames, or other physical layer signaling sequences, supporting PRS signals (i.e. a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

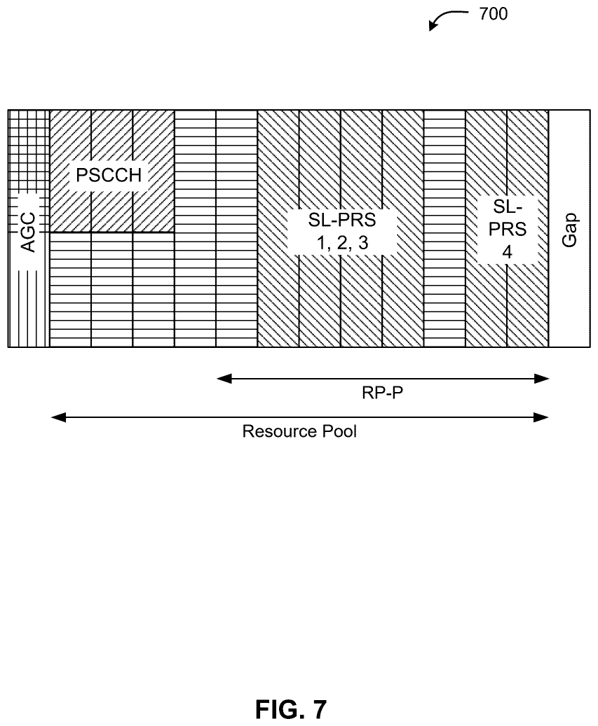

FIG. 7 is a diagram showing an example of a sidelink resource pool 700. In the example of FIG. 7, time is represented horizontally and frequency is represented vertically. In the time domain, the length of each block is an OFDM symbol, and the 14 symbols make up a slot. In the frequency domain, the height of each block is a sub-channel.

In the example of FIG. 7, the entire slot (except for the first and last symbols) can be a resource pool for sidelink transmission and/or reception. That is, any of the symbols other than the first and last can be allocated for transmission and/or reception. However, an RP-P for sidelink transmission/reception is allocated in the last eight pre-gap symbols of the slot. As such, non-sidelink positioning data, such as user data, CSI-RS, and control information, can only be transmitted in the first four post-AGC symbols and not in the last eight pre-gap symbols to prevent a collision with the configured RP-P. Non-sidelink positioning data that would otherwise be transmitted in the last eight pre-gap symbols can be punctured or muted, and/or non-sidelink data that would normally span more than the four post-AGC symbols can be rate matched to fit into the four post-AGC symbols.

Sidelink positioning reference signals (SL-PRS) have been defined to enable sidelink positioning procedures among UEs. Like PRS and SRS, SL-PRS resources are composed of one or more resource elements (i.e., one OFDM symbol in the time domain and one subcarrier in the frequency domain). SL-PRS resources can be designed with a comb-based pattern to enable fast Fourier transform (FFT)-based processing at the receiver. SL-PRS resources can be composed of unstaggered, or only partially staggered, resource elements in the frequency domain to provide small time of arrival (TOA) uncertainty and reduced overhead of each SL-PRS resource. In the example of FIG. 7, as shown, four SL-PRS resources (labeled SL-PRS 1, 2, 3, 4) are transmitted (or scheduled for transmission) in the RP-P. Note that although FIG. 7 illustrates the SL-PRS as contiguous in the frequency domain, they may instead follow a comb pattern within the sub-channel.

SL-PRS may be associated with specific RP-Ps (e.g., certain SL-PRS may be allocated in certain RP-Ps). SL-PRS can be configured to feature intra-slot repetition (not shown in FIG. 7) to allow for combining gains (if needed). Inter-UE coordination of RP-Ps may be performed to provide for dynamic SL-PRS and data multiplexing while minimizing SL-PRS collisions.

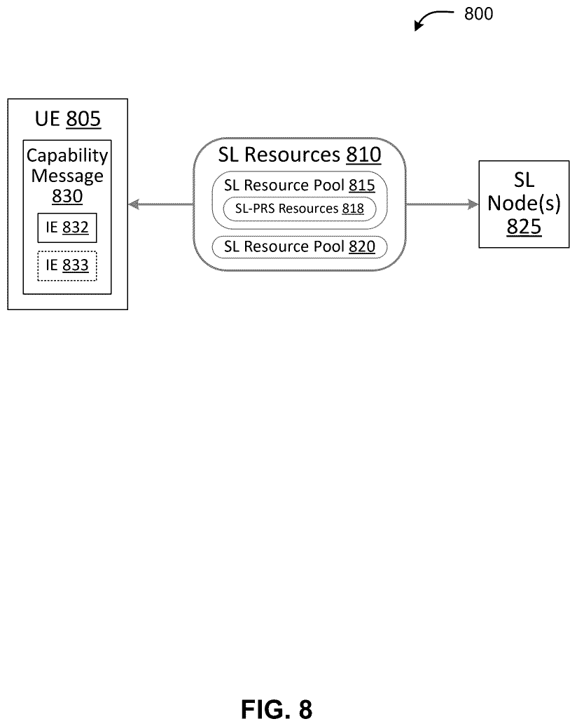

FIG. 8 is a block diagram of an operating environment 800 in which techniques disclosed herein for accommodating sidelink positioning in channel load management may be implemented. In operating environment 800, a UE 805 can wirelessly communicate with one or more sidelink node(s) 825 using sidelink resources 810. Sidelink node(s) 825 can include other sidelink-capable UE(s) and/or device(s) of other type(s) that are capable of sidelink communications. Sidelink resources 810 can include a sidelink resource pool 815 and a sidelink resource pool 820. Sidelink resource pool 815, which can be similar to sidelink resource pool 700 of FIG. 7, comprises SL-PRS resources 818. Sidelink resource pool 820 does not comprise SL-PRS resources.

In order to detect and mitigate sidelink congestion in operating environment 800, UE 805 may perform sidelink channel busy ratio (SL CBR) and sidelink channel occupancy ratio (SL CR) measurements. The SL CBR (or simply CBR) can be used by UEs and other network entities (if reported) to manage the channel load and, if necessary, adapt the resources dedicated to sidelink. CBR measurements can provide indications of congestion on the medium. The CBR measured in a slot n can be defined as the portion of sub-channels in the resource pool whose sidelink received signal strength indication (SL-RSSI) measured by the UE exceeds a (pre-)configured threshold sensed over a CBR measurement window [n−a, n−1], where a is equal to 100 or 100.24 slots, and u is the numerology in effect with respect to (and defining the sub-carrier spacing of) the resource pool in question. The SL CR (or simply CR) evaluated at slot n can be defined as the total number of sub-channels used for a UE's transmissions in slots [n−a, n−1] and granted in slots [n, n+b] divided by the total number of configured sub-channels in the transmission pool over [n−a, n+b], where a is a positive integer, b is a non-negative integer, and a+b+1=1000 or 1000*24 slots.

UE 805 can implement a congestion control mechanism according to which it controls its utilization of SL resources 810 to satisfy constraints upon its usage of those resources. With respect to sidelink data transmissions of a given priority level k on a given sidelink resource pool during slot n, UE 805 can control its utilization of that sidelink resource pool to ensure that the sum of its CRs for priority levels less than or equal to k, evaluated at slot n-N, is less than or equal to a CR limit, where N represents a congestion control processing time. This CR limit can depend on the priority level k and the CBR value that UE 805 measures for the slot n-N. UE 805 can measure the CBR of a sidelink resource pool for slot n-N, identify, for the given priority level k, a CR limit corresponding to a CBR range containing the measured CBR, and control its utilization of the sidelink resource pool during slot n to observe that CR limit.

A congestion control processing capability of UE 805 can dictate a congestion control processing time value set comprising values of N to be applied for various values of u. UE 805 can apply different values of congestion control processing time N depending on the applicable numerology value u. In conducting congestion control with respect to a particular sidelink resource pool, UE 805 can identify the applicable value of u with respect to that sidelink resource pool, identify a value of N corresponding to that value of u according to a congestion control processing capability of UE 805, and apply that value of Nin conjunction with congestion control of the sidelink resource pool.

The congestion control processing times (values of N) that UE 805 observes for sidelink resource pools not comprising SL-PRS resources (e.g., sidelink resource pool 820) may be non-ideal for use in conjunction with congestion control of sidelink resource pools that comprise SL-PRS resources (e.g., sidelink resource pool 815). Factors that can render the “non-SL-PRS” congestion control processing times non-ideal for sidelink resource pools comprising SL-PRS resources can include the possibility of SL-PRS resources occupying larger bandwidths than sidelink data resources and the possibility of multiple UEs transmitting SL-PRS during the same symbols (e.g., using code orthogonality or comb structures such as those of FIG. 6).

In order to improve the results of congestion control in conjunction with congestion control of sidelink resource pools, such as sidelink resource pool 815, that comprise SL-PRS resources, UE 805 can be configured to recognize/implement different congestion control processing time value set(s) for such sidelink resource pools than it does for sidelink resource pools not comprising SL-PRS resources.

In some implementations, UE 805 can be configured to recognize/implement an SL-PRS congestion control processing capability that is distinct from a congestion control processing capability that UE 805 recognizes/implements in conjunction with congestion control of sidelink resource pools not comprising SL-PRS resources. In such implementations, the SL-PRS congestion control processing capability can dictate, for sidelink resource pools comprising SL-PRS resources (e.g., sidelink resource pool 815), a different congestion control processing time value set than that governing congestion control of sidelink resource pools not comprising SL-PRS resources (e.g., sidelink resource pool 820).

In implementations in which UE 805 is configured to recognize/implement a distinct SL-PRS congestion control processing capability, UE 805 can report that SL-PRS congestion control processing capability to other device(s) (e.g., an ng-eNB or gNB, other UE(s)) by transmitting a capability message 830 that indicates the SL-PRS congestion control processing capability of UE 805. In some implementations, capability message 830 can include an information element (IE) 832 that indicates the SL-PRS congestion control processing capability of UE 805.

In some implementations, UE 805 can also use capability message 830 to report a congestion control processing capability of UE 805 with respect to sidelink resource pools not comprising SL-PRS resources (e.g., sidelink resource pool 820). In some implementations, in addition to indicating an SL-PRS congestion control processing capability of UE 805, IE 832 can indicate a congestion control processing capability of UE 805 with respect to sidelink resource pools not comprising SL-PRS resources. In some other implementations, capability message 830 can include a different IE 833 that indicates the congestion control processing capability of UE 805 with respect to sidelink resource pools not comprising SL-PRS resources.

In some implementations, UE 805 can determine an applicable congestion control processing time value for congestion control of sidelink resource pool 815 in accordance with the SL-PRS congestion control processing capability of UE 805. This can involve identifying a congestion control processing time value set corresponding to the SL-PRS congestion control processing capability of UE 805, and identifying a value in the congestion control processing time value set as the applicable congestion control processing time value (e.g., based on a sub-carrier spacing of sidelink resource pool 815).

In some implementations, distinct SL-PRS congestion control processing time value sets may be explicitly defined and associated with various possible SL-PRS congestion control processing capabilities. In some such implementations, UE 805 can identify an SL-PRS congestion control processing time value set corresponding to the SL-PRS congestion control processing capability of UE 805, and can identify a value in that SL-PRS congestion control processing time value set as the applicable congestion control processing time value for congestion control of sidelink resource pool 815. In some implementations, the explicitly defined SL-PRS congestion control processing time value sets can include some value sets that apply in sidelink Mode 1 and other, different value sets that apply in sidelink Mode 2.

In some implementations, a congestion control processing capability of UE 805 for congestion control of sidelink resource pools not comprising SL-PRS resources can serve as a common congestion control processing capability that also constitutes an SL-PRS congestion control processing capability of UE 805. In some such implementations, distinct SL-PRS congestion control processing time value sets may be explicitly defined and associated with various possible common congestion control processing capabilities. In some implementations, capability message 830 can indicate (e.g., using IE 832) such a common congestion control processing capability of UE 805. In some implementations, according to a common congestion control processing capability indicated by capability message 830, UE 805 may identify both an applicable SL-PRS congestion control processing time value set and an applicable congestion control processing time value set for congestion control of sidelink resource pools not comprising SL-PRS resources.

In some implementations in which a common congestion control processing capability is implemented, distinct SL-PRS congestion control processing time value sets may not be explicitly defined. In some such implementations, a scheme may be defined according to which SL-PRS congestion control processing time values are determined as a function of congestion control processing time values for sidelink resource pools not comprising SL-PRS resources. Such a scheme may specify modification factors according to which values in a non-SL-PRS congestion control processing time value set are to be modified in order to determine SL-PRS congestion control processing time values. Such modification factors can generally define modifications to be made to non-SL-PRS congestion control processing time values based on characteristics of SL-PRS resource allocation/distribution. Such characteristics can include, for example, a ratio between an SL-PRS resource pool bandwidth and a SL data resource pool bandwidth, an number of SL-PRS resources configured per SL-PRS instance, an SL-PRS repetition factor, and/or a comb/symbol structure of SL-PRS transmissions.

In some implementations, according to such a scheme, UE 805 may determine the applicable congestion control processing time value for congestion control of sidelink resource pool 815 based on a non-SL-PRS congestion control processing time value set. In some implementations, UE 805 may modify a value in the non-SL-PRS congestion control processing time value set according to one or more modification factors to determine the applicable congestion control processing time value for congestion control of sidelink resource pool 815. In an example implementation, UE 805 may scale a value in a non-SL-PRS congestion control processing time value set based on a ratio between a bandwidth of sidelink resource pool 815 and a bandwidth of sidelink resource pool 820 in order to determine the applicable congestion control processing time value for congestion control of sidelink resource pool 815.

In some implementations, UE 805 can be configured to recognize/implement a sidelink congestion control SL-PRS resource processing capability. In some implementations, associated with the sidelink congestion control SL-PRS resource processing capability can be a limit on a number of SL-PRS resources to be processed over a given amount of time (e.g., slot or number of slots) in conjunction with congestion control of sidelink resource pools comprising SL-PRS resources (e.g., sidelink resource pool 815). If the number of SL-PRS resources in the sidelink resource pool in question over the relevant time interval exceeds the maximum number to be processed, then once UE 805 has processed a number of SL-PRS resources equal to the limit, it can ignore the remaining SL-PRS resources for purposes of CBR and CR determination. In some implementations, capability message 830 can indicate a sidelink congestion control SL-PRS resource processing capability of UE 805.

In some implementations, UE 805 can be configured to also recognize/implement a general SL-PRS resource processing capability that indicates a maximum number of SL-PRS resources that UE 805 can process over a given amount of time (e.g., slot or number of slots) in general. In some implementations, the limit imposed by the sidelink congestion control SL-PRS resource processing capability upon the number of SL-PRS resources to be processed in conjunction with congestion control can be defined as a function of the overall limit indicated by the general SL-PRS resource processing capability. In some implementations, for instance, the limit imposed by the sidelink congestion control SL-PRS resource processing capability can be defined to be equal to the overall limit indicated by the general SL-PRS resource processing capability multiplied by a scaling factor. In some implementations, capability message 830 can indicate a general SL-PRS resource processing capability of UE 805. In some implementations, capability message 830 can indicate both a general SL-PRS resource processing capability of UE 805 and a sidelink congestion control SL-PRS resource processing capability of UE 805.

In some implementations, UE 805 can be configured to recognize SL-PRS resource processing capability limits expressed in the form of parameter value pairs [D,T]. In some implementations, based on a specified parameter value pair [D,T], UE 805 can recognize a duration D (in ms) of SL-PRS symbols that UE 805 can process every T ms.

In some implementations, UE 805 can be configured to recognize/implement a sidelink congestion control SL-PRS resource processing capability that indicates a value pair [D,T] applicable to sidelink congestion control. In some implementations, UE 805 can be configured to recognize the sidelink congestion control SL-PRS resource processing capability as indicating a duration D (in ms) of SL-PRS symbols that UE 805 can process every T ms in conjunction with sidelink congestion control.

In some implementations, UE 805 can be configured to also recognize/implement a general SL-PRS resource processing capability that indicates a value pair [D,T] defining SL-PRS resource processing capability limitations not specific to the context of sidelink congestion control. In some implementations, UE 805 can be configured to recognize the general SL-PRS resource processing capability as indicating a duration D (in ms) of SL-PRS symbols that UE 805 can process every T ms in general.

In some implementations, a general set of allowed value pairs [D,T] can be defined, and the general SL-PRS resource processing capability can indicate one of the allowed value pairs [D,T] in the general set. In some implementations, the general set of allowed value pairs [D,T] can also serve as a set of allowed value pairs [D,T] for sidelink congestion control, and the sidelink congestion control SL-PRS resource processing capability can indicate one of the allowed value pairs [D,T] in the general set. In some other implementations, a distinct set of allowed value pairs [D,T] can be defined for sidelink congestion control, and the sidelink congestion control SL-PRS resource processing capability can indicate one of the allowed value pairs [D,T] in that distinct set.

In some implementations, UE 805 can be configured to recognize/implement an SL-PRS buffering capability. In some implementations, the SL-PRS buffering capability can indicate a granularity of SL-PRS buffering. In some implementations, the SL-PRS buffering capability can be set to one value to indicate slot-level SL-PRS buffering, or can be set to another value to indicate sub-slot/symbol-level buffering. In some implementations, capability message 830 can indicate an SL-PRS buffering capability of UE 805. In some implementations, UE 805 can be configured to also recognize/implement a DL-PRS buffering capability indicating a granularity of DL-PRS buffering (e.g., slot-level or sub-slot/symbol-level), and capability message 830 can indicate both a DL-PRS buffering capability of UE 805 and an SL-PRS buffering capability of UE 805.

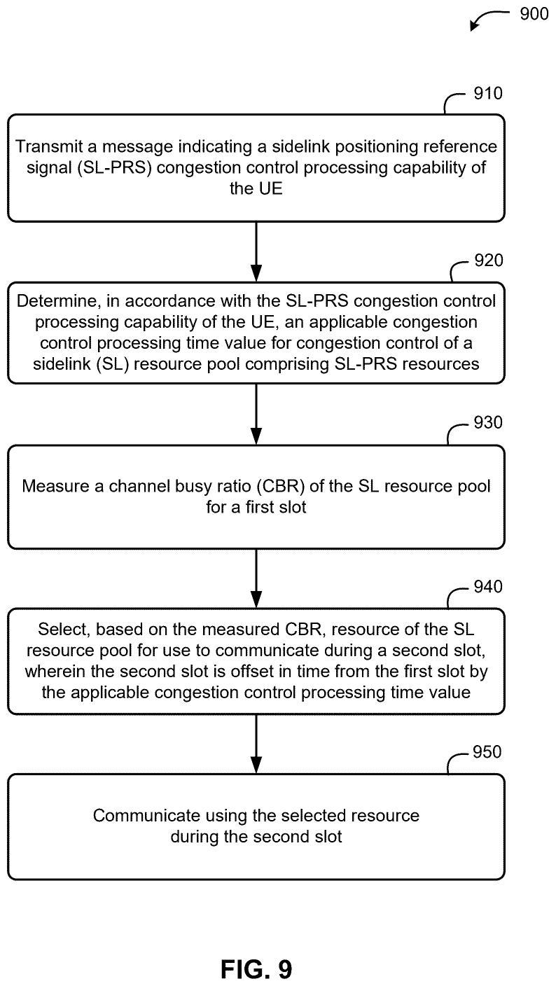

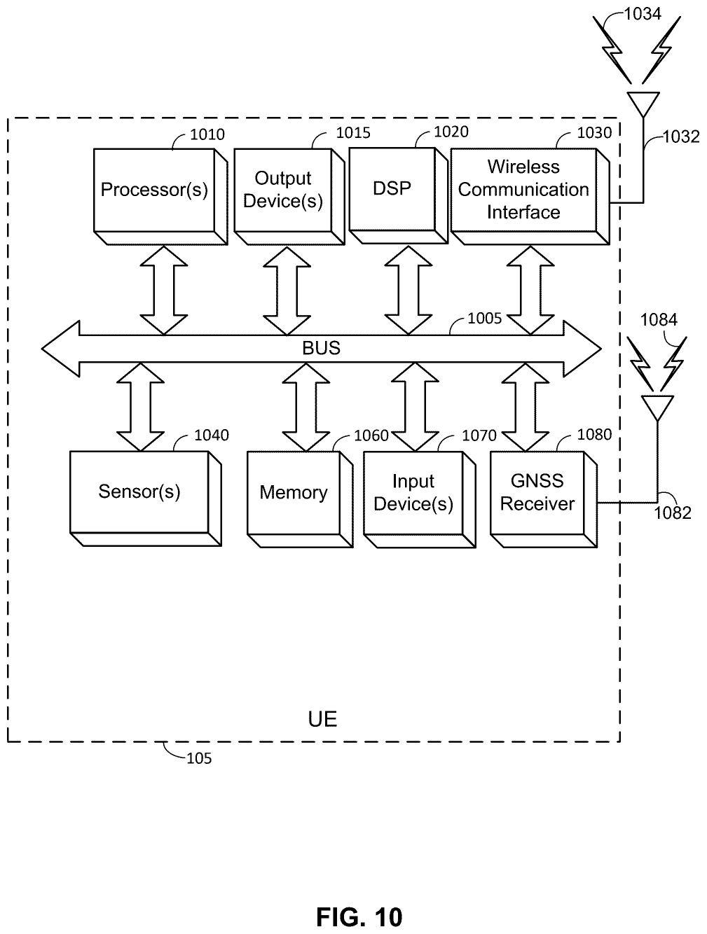

FIG. 9 is a flow diagram of a method 900 for wireless communication by a UE according to aspects of the disclosure. Means for performing the functionality illustrated in one or more of the blocks shown in FIG. 9 may be performed by hardware and/or software components of a UE. Example components of a UE are illustrated in FIG. 10, which is described in more detail below.

At block 910, the functionality comprises transmitting a message indicating a sidelink positioning reference signal (SL-PRS) congestion control processing capability of a UE. For example, in operating environment 800 of FIG. 8, UE 805 can transmit capability message 830, which can indicate an SL-PRS congestion control processing capability of UE 805.

In some implementations, the message transmitted at block 910 can comprise an IE (e.g., IE 832 of FIG. 8) that indicates a congestion control processing capability that constitutes the SL-PRS congestion control processing capability of the UE. In some such implementations, the message can also comprise a second IE (e.g., IE 833 of FIG. 8) that indicates a congestion control processing capability that constitutes a congestion control processing capability of the UE for congestion control of SL resource pools (e.g., SL resource pool 820 of FIG. 8) that do not comprise SL-PRS resources. In some implementations, the message can comprise an IE (e.g., IE 832 of FIG. 8) that indicates a common congestion control processing capability that constitutes both an SL-PRS congestion control processing capability of the UE and a congestion control processing capability of the UE for congestion control of SL resource pools (e.g., SL resource pool 820 of FIG. 8) that do not comprise SL-PRS resources.

In some implementations, the message transmitted at block 910 can indicate a sidelink congestion control SL-PRS resource processing capability of the UE. In some implementations, the sidelink congestion control SL-PRS resource processing capability can specify a limit on a number of SL-PRS resources to be processed by the UE over a given amount of time (e.g., slot or number of slots) in conjunction with congestion control of sidelink resource pools comprising SL-PRS resources (e.g., sidelink resource pool 815 of FIG. 8). In some implementations, the sidelink congestion control SL-PRS resource processing capability can specify a parameter value pair [D,T], and the UE can be configured to recognize the sidelink congestion control SL-PRS resource processing capability as indicating a duration D (in ms) of SL-PRS symbols that the UE can process every T ms in conjunction with sidelink congestion control.

In some implementations, the message transmitted at block 910 can indicate an SL-PRS buffering capability of the UE. In some implementations, the SL-PRS buffering capability can indicate a granularity of SL-PRS buffering. In some implementations, the SL-PRS buffering capability can be set to one value to indicate slot-level SL-PRS buffering, or can be set to another value to indicate sub-slot/symbol-level buffering.

Means for performing functionality at block 910 may comprise a bus 1005, processors 1010, digital signal processor (DSP) 1020, wireless communication interface 1030, memory 1060, and/or other components of a UE, as illustrated in FIG. 10, which is described in more detail hereafter.

At block 920, the functionality comprises determining, in accordance with the SL-PRS congestion control processing capability of the UE, an applicable congestion control processing time value for congestion control of a sidelink (SL) resource pool comprising SL-PRS resources. For example, in operating environment 800 of FIG. 8, UE 805 can determine an applicable congestion control processing time value for congestion control of SL resource pool 815 in accordance with the SL-PRS congestion control processing capability of UE 805.

In some implementations, the applicable congestion control processing time value for the SL resource pool (e.g., SL resource pool 815 of FIG. 8) comprising SL-PRS resources can be determined based on a congestion control processing time value set corresponding to the SL-PRS congestion control processing capability of the UE. In some implementations, a value in the congestion control processing time value set corresponding to the SL-PRS congestion control processing capability of the UE can be identified as the applicable congestion control processing time value based on a sub-carrier spacing (or associated numerology value u) of the SL resource pool (e.g., SL resource pool 815 of FIG. 8) comprising SL-PRS resources.

In some implementations, the message transmitted at block 910 can comprise an IE (e.g., IE 833 of FIG. 8) that indicates a congestion control processing capability that constitutes a congestion control processing capability of the UE for congestion control of an SL resource pool (e.g., SL resource pool 820 of FIG. 8) that does not comprise SL-PRS resources, and an applicable congestion control processing time value for congestion control of that SL resource pool can be determined in accordance with that congestion control processing capability.

In some implementations, the message transmitted at block 910 can comprise an IE (e.g., IE 832 of FIG. 8) that indicates a common congestion control processing capability as described above, and the functionality at block 920 can comprise determining, in accordance with that common congestion control processing capability, both the applicable congestion control processing time value for congestion control of an SL resource pool (e.g., SL resource pool 815 of FIG. 8) comprising SL-PRS resources and an applicable congestion control processing time value for congestion control of an SL resource pool (e.g., SL resource pool 820 of FIG. 8) that does not comprise SL-PRS resources. In some such implementations, the applicable congestion control processing time value for congestion control of the SL resource pool (e.g., SL resource pool 820 of FIG. 8) that does not comprise SL-PRS resources can be modified according to one or more modification factors to determine the applicable congestion control processing time value for congestion control of the SL resource pool (e.g., SL resource pool 815 of FIG. 8) comprising SL-PRS resources. In some implementations, such modifying of the applicable congestion control processing time value for congestion control of the SL resource pool not comprising SL-PRS resources (e.g., SL resource pool 820 of FIG. 8) can include scaling that applicable congestion control processing time value based on a ratio between a bandwidth of the SL resource pool comprising SL-PRS resources and a bandwidth of the SL resource pool not comprising SL-PRS resources (e.g., a ratio between a bandwidth of SL resource pool 815 and a bandwidth of SL resource pool 820).

Means for performing functionality at block 920 may comprise a bus 1005, processors 1010, digital signal processor (DSP) 1020, wireless communication interface 1030, memory 1060, and/or other components of a UE, as illustrated in FIG. 10, which is described in more detail hereafter.

At block 930, the functionality comprises measuring a channel busy ratio (CBR) of the SL resource pool comprising SL-PRS resources for a first slot. For example, in operating environment 800 of FIG. 8, UE 805 can measure a CBR of SL resource pool 815 for a slot n-N, where N represents the applicable congestion control processing time value determined at block 920.

Means for performing functionality at block 930 may comprise a bus 1005, processors 1010, digital signal processor (DSP) 1020, wireless communication interface 1030, memory 1060, and/or other components of a UE, as illustrated in FIG. 10, which is described in more detail hereafter.

At block 940, the functionality comprises selecting, based on the measured CBR, resource(s) of the SL resource pool for use by the UE to communicate during a second slot, wherein the second slot is offset in time from the first slot by the applicable congestion control processing time value. For example, in operating environment 800 of FIG. 8, UE 805 can select, based on a CBR measured for slot n-N, resource(s) of SL resource pool 815 for use to communicate during a slot n. In some implementations, the selection of the resource(s) of the SL resource pool can be performed to ensure, for each possible value of k, that the sum of the UEs CRs for priority levels less than or equal to priority level k, evaluated at slot n-N, is less than or equal to a CR limit. In some implementations, as previously described, the CR limit can vary depending on the value of k and the CBR measured at block 930.

Means for performing functionality at block 940 may comprise a bus 1005, processors 1010, digital signal processor (DSP) 1020, wireless communication interface 1030, memory 1060, and/or other components of a UE, as illustrated in FIG. 10, which is described in more detail hereafter.

At block 950, the functionality comprises communicating using the selected resource(s) during the second slot. For example, in operating environment 800 of FIG. 8, UE 805 can communicate, during slot n using resource(s) of SL resource pool 815 selected at block 940.

Means for performing functionality at block 950 may comprise a bus 1005, processors 1010, digital signal processor (DSP) 1020, wireless communication interface 1030, memory 1060, and/or other components of a UE, as illustrated in FIG. 10, which is described in more detail hereafter.

FIG. 10 is a block diagram of an embodiment of a UE 105, which can be utilized as described herein above (e.g., in association with FIGS. 1-3 and 8-9). For example, the UE 105 can perform one or more of the functions of the method shown in FIG. 9. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 10.

The UE 105 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 105 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 105 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The UE 105 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 105 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 105 (and/or processor(s) 1010 or DSP 1020 within UE 105). In some embodiments, then, such code and/or instructions can be used to configure and/or adapt a general-purpose computer (or other device) to perform one or more operations in accordance with the described methods.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method for wireless communication by a user equipment (UE), the method comprising transmitting a message indicating a sidelink positioning reference signal (SL-PRS) congestion control processing capability of the UE, determining, in accordance with the SL-PRS congestion control processing capability of the UE, an applicable congestion control processing time value for congestion control of a first sidelink (SL) resource pool, the first SL resource pool comprising SL-PRS resources, measuring a channel busy ratio (CBR) of the first SL resource pool for a first slot, selecting, based on the measured CBR, a resource of the first SL resource pool for use to communicate during a second slot, wherein the second slot is offset in time from the first slot by the applicable congestion control processing time value, and communicating using the selected resource during the second slot.
Clause 2. The method of clause 1, wherein the applicable congestion control processing time value is determined based on a congestion control processing time value set corresponding to the SL-PRS congestion control processing capability of the UE.
Clause 3. The method of clause 2, comprising identifying a value in the congestion control processing time value set as the applicable congestion control processing time value based on a sub-carrier spacing of the first SL resource pool.
Clause 4. The method of any of clauses 1 to 3, wherein the message comprises a first information element indicating a first congestion control processing capability that constitutes the SL-PRS congestion control processing capability of the UE, and a second information element indicating a second congestion control processing capability that constitutes a congestion control processing capability of the UE for congestion control of a second SL resource pool, the second SL resource pool not comprising SL-PRS resources.
Clause 5. The method of clause 4, comprising determining, in accordance with the second congestion control processing capability, an applicable congestion control processing time value for congestion control of the second SL resource pool.
Clause 6. The method of any of clauses 1 to 3, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.
Clause 7. The method of clause 6, comprising determining, in accordance with the common congestion control processing capability a first congestion control processing time value constituting the applicable congestion control processing time value for congestion control of the first SL resource pool, and a second congestion control processing time value constituting an applicable congestion control processing time value for congestion control of the second SL resource pool.
Clause 8. The method of clause 7, comprising modifying the second congestion control processing time value according to one or more modification factors to determine the first congestion control processing time value.
Clause 9. The method of clause 8, wherein the modifying the second congestion control processing time value according to the one or more modification factors includes scaling the second congestion control processing time value based on a ratio between a bandwidth of the first SL resource pool and a bandwidth of the second SL resource pool.
Clause 10. The method of any of clauses 1 to 9, wherein the message indicates a sidelink congestion control SL-PRS resource processing capability of the UE.
Clause 11. The method of any of clauses 1 to 10, wherein the message indicates an SL-PRS buffering capability of the UE.
Clause 12. A user equipment (UE), comprising a transceiver, a memory, and one or more processors communicatively coupled with the transceiver and the memory, wherein the one or more processors are configured to transmit, via the transceiver, a message indicating a sidelink positioning reference signal (SL-PRS) congestion control processing capability of the UE, determine, in accordance with the SL-PRS congestion control processing capability of the UE, an applicable congestion control processing time value for congestion control of a first sidelink (SL) resource pool, the first SL resource pool comprising SL-PRS resources, measure a channel busy ratio (CBR) of the first SL resource pool for a first slot, select, based on the measured CBR, a resource of the first SL resource pool for use to communicate during a second slot, wherein the second slot is offset in time from the first slot by the applicable congestion control processing time value, and communicate using the selected resource during the second slot.
Clause 13. The UE of clause 12, wherein the applicable congestion control processing time value is determined based on a congestion control processing time value set corresponding to the SL-PRS congestion control processing capability of the UE.
Clause 14. The UE of clause 13, wherein the one or more processors are configured to identify a value in the congestion control processing time value set as the applicable congestion control processing time value based on a sub-carrier spacing of the first SL resource pool.
Clause 15. The UE of any of clauses 12 to 14, wherein the message comprises a first information element indicating a first congestion control processing capability that constitutes the SL-PRS congestion control processing capability of the UE, and a second information element indicating a second congestion control processing capability that constitutes a congestion control processing capability of the UE for congestion control of a second SL resource pool, the second SL resource pool not comprising SL-PRS resources.
Clause 16. The UE of clause 15, wherein the one or more processors are configured to determine, in accordance with the second congestion control processing capability, an applicable congestion control processing time value for congestion control of the second SL resource pool.
Clause 17. The UE of any of clauses 12 to 14, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.
Clause 18. The UE of clause 17, wherein the one or more processors are configured to determine, in accordance with the common congestion control processing capability a first congestion control processing time value constituting the applicable congestion control processing time value for congestion control of the first SL resource pool, and a second congestion control processing time value constituting an applicable congestion control processing time value for congestion control of the second SL resource pool.
Clause 19. The UE of clause 18, wherein the one or more processors are configured to modify the second congestion control processing time value according to one or more modification factors to determine the first congestion control processing time value.
Clause 20. The UE of clause 19, wherein the modifying the second congestion control processing time value according to the one or more modification factors includes scaling the second congestion control processing time value based on a ratio between a bandwidth of the first SL resource pool and a bandwidth of the second SL resource pool.
Clause 21. The UE of any of clauses 12 to 20, wherein the message indicates a sidelink congestion control SL-PRS resource processing capability of the UE.
Clause 22. The UE of any of clauses 12 to 21, wherein the message indicates an SL-PRS buffering capability of the UE.
Clause 23. An apparatus for wireless communication, comprising means for transmitting a message indicating a sidelink positioning reference signal (SL-PRS) congestion control processing capability of a user equipment (UE), means for determining, in accordance with the SL-PRS congestion control processing capability of the UE, an applicable congestion control processing time value for congestion control of a first sidelink (SL) resource pool, the first SL resource pool comprising SL-PRS resources, means for measuring a channel busy ratio (CBR) of the first SL resource pool for a first slot, means for selecting, based on the measured CBR, a resource of the first SL resource pool for use to communicate during a second slot, wherein the second slot is offset in time from the first slot by the applicable congestion control processing time value, and means for communicating using the selected resource during the second slot.
Clause 24. The apparatus of clause 23, wherein the applicable congestion control processing time value is determined based on a congestion control processing time value set corresponding to the SL-PRS congestion control processing capability of the UE.
Clause 25. The apparatus of clause 24, comprising means for identifying a value in the congestion control processing time value set as the applicable congestion control processing time value based on a sub-carrier spacing of the first SL resource pool.
Clause 26. The apparatus of any of clauses 23 to 25, wherein the message comprises a first information element indicating a first congestion control processing capability that constitutes the SL-PRS congestion control processing capability of the UE, and a second information element indicating a second congestion control processing capability that constitutes a congestion control processing capability of the UE for congestion control of a second SL resource pool, the second SL resource pool not comprising SL-PRS resources.
Clause 27. The apparatus of clause 26, comprising means for determining, in accordance with the second congestion control processing capability, an applicable congestion control processing time value for congestion control of the second SL resource pool.
Clause 28. The apparatus of any of clauses 23 to 25, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.
Clause 29. The apparatus of clause 28, comprising means for determining, in accordance with the common congestion control processing capability a first congestion control processing time value constituting the applicable congestion control processing time value for congestion control of the first SL resource pool, and a second congestion control processing time value constituting an applicable congestion control processing time value for congestion control of the second SL resource pool.
Clause 30. The apparatus of clause 29, comprising means for modifying the second congestion control processing time value according to one or more modification factors to determine the first congestion control processing time value.
Clause 31. The apparatus of clause 30, wherein the modifying the second congestion control processing time value according to the one or more modification factors includes scaling the second congestion control processing time value based on a ratio between a bandwidth of the first SL resource pool and a bandwidth of the second SL resource pool.
Clause 32. The apparatus of any of clauses 23 to 31, wherein the message indicates a sidelink congestion control SL-PRS resource processing capability of the UE.
Clause 33. The apparatus of any of clauses 23 to 32, wherein the message indicates an SL-PRS buffering capability of the UE.
Clause 34. A non-transitory computer-readable medium storing instructions for wireless communication by a user equipment (UE), the instructions comprising code for transmitting a message indicating a sidelink positioning reference signal (SL-PRS) congestion control processing capability of the UE, determining, in accordance with the SL-PRS congestion control processing capability of the UE, an applicable congestion control processing time value for congestion control of a first sidelink (SL) resource pool, the first SL resource pool comprising SL-PRS resources, measuring a channel busy ratio (CBR) of the first SL resource pool for a first slot, selecting, based on the measured CBR, a resource of the first SL resource pool for use to communicate during a second slot, wherein the second slot is offset in time from the first slot by the applicable congestion control processing time value, and communicating using the selected resource during the second slot.
Clause 35. The non-transitory computer-readable medium of clause 34, wherein the applicable congestion control processing time value is determined based on a congestion control processing time value set corresponding to the SL-PRS congestion control processing capability of the UE.
Clause 36. The non-transitory computer-readable medium of clause 35, the instructions comprising code for identifying a value in the congestion control processing time value set as the applicable congestion control processing time value based on a sub-carrier spacing of the first SL resource pool.
Clause 37. The non-transitory computer-readable medium of any of clauses 34 to 36, wherein the message comprises a first information element indicating a first congestion control processing capability that constitutes the SL-PRS congestion control processing capability of the UE, and a second information element indicating a second congestion control processing capability that constitutes a congestion control processing capability of the UE for congestion control of a second SL resource pool, the second SL resource pool not comprising SL-PRS resources.
Clause 38. The non-transitory computer-readable medium of clause 37, the instructions comprising code for determining, in accordance with the second congestion control processing capability, an applicable congestion control processing time value for congestion control of the second SL resource pool.
Clause 39. The non-transitory computer-readable medium of any of clauses 34 to 36, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.
Clause 40. The non-transitory computer-readable medium of clause 39, the instructions comprising code for determining, in accordance with the common congestion control processing capability a first congestion control processing time value constituting the applicable congestion control processing time value for congestion control of the first SL resource pool, and a second congestion control processing time value constituting an applicable congestion control processing time value for congestion control of the second SL resource pool.
Clause 41. The non-transitory computer-readable medium of clause 40, the instructions comprising code for modifying the second congestion control processing time value according to one or more modification factors to determine the first congestion control processing time value.
Clause 42. The non-transitory computer-readable medium of clause 41, wherein the modifying the second congestion control processing time value according to the one or more modification factors includes scaling the second congestion control processing time value based on a ratio between a bandwidth of the first SL resource pool and a bandwidth of the second SL resource pool.
Clause 43. The non-transitory computer-readable medium of any of clauses 34 to 42, wherein the message indicates a sidelink congestion control SL-PRS resource processing capability of the UE.
Clause 44. The non-transitory computer-readable medium of any of clauses 34 to 43, wherein the message indicates an SL-PRS buffering capability of the UE.

1. A method for wireless communication by a user equipment (UE), the method comprising:
transmitting a message indicating a sidelink positioning reference signal (SL-PRS) congestion control processing capability of the UE;
determining, in accordance with the SL-PRS congestion control processing capability of the UE, an applicable congestion control processing time value for congestion control of a first sidelink (SL) resource pool, the first SL resource pool comprising SL-PRS resources;
measuring a channel busy ratio (CBR) of the first SL resource pool for a first slot;
selecting, based on the measured CBR, a resource of the first SL resource pool for use to communicate during a second slot, wherein the second slot is offset in time from the first slot by the applicable congestion control processing time value; and
communicating using the selected resource during the second slot.

2. The method of claim 1, wherein the applicable congestion control processing time value is determined based on a congestion control processing time value set corresponding to the SL-PRS congestion control processing capability of the UE.

3. The method of claim 2, comprising identifying a value in the congestion control processing time value set as the applicable congestion control processing time value based on a sub-carrier spacing of the first SL resource pool.

4. The method of claim 1, wherein the message comprises:
a first information element indicating a first congestion control processing capability that constitutes the SL-PRS congestion control processing capability of the UE; and
a second information element indicating a second congestion control processing capability that constitutes a congestion control processing capability of the UE for congestion control of a second SL resource pool, the second SL resource pool not comprising SL-PRS resources.

5. The method of claim 4, comprising determining, in accordance with the second congestion control processing capability, an applicable congestion control processing time value for congestion control of the second SL resource pool.

6. The method of claim 1, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.

7. The method of claim 6, comprising:
determining, in accordance with the common congestion control processing capability:
a first congestion control processing time value constituting the applicable congestion control processing time value for congestion control of the first SL resource pool; and
a second congestion control processing time value constituting an applicable congestion control processing time value for congestion control of the second SL resource pool.

8. The method of claim 7, comprising modifying the second congestion control processing time value according to one or more modification factors to determine the first congestion control processing time value.

9. The method of claim 8, wherein the modifying the second congestion control processing time value according to the one or more modification factors includes scaling the second congestion control processing time value based on a ratio between a bandwidth of the first SL resource pool and a bandwidth of the second SL resource pool.

10. The method of claim 1, wherein the message indicates a sidelink congestion control SL-PRS resource processing capability of the UE.

11. The method of claim 1, wherein the message indicates an SL-PRS buffering capability of the UE.

12. A user equipment (UE), comprising:
a transceiver;
a memory; and
one or more processors communicatively coupled with the transceiver and the memory, wherein the one or more processors are configured to:
transmit, via the transceiver, a message indicating a sidelink positioning reference signal (SL-PRS) congestion control processing capability of the UE;
determine, in accordance with the SL-PRS congestion control processing capability of the UE, an applicable congestion control processing time value for congestion control of a first sidelink (SL) resource pool, the first SL resource pool comprising SL-PRS resources;
measure a channel busy ratio (CBR) of the first SL resource pool for a first slot;
select, based on the measured CBR, a resource of the first SL resource pool for use to communicate during a second slot, wherein the second slot is offset in time from the first slot by the applicable congestion control processing time value; and
communicate using the selected resources during the second slot.

13. The UE of claim 12, wherein the applicable congestion control processing time value is determined based on a congestion control processing time value set corresponding to the SL-PRS congestion control processing capability of the UE.

14. The UE of claim 13, wherein the one or more processors are configured to identify a value in the congestion control processing time value set as the applicable congestion control processing time value based on a sub-carrier spacing of the first SL resource pool.

15. The UE of claim 12, wherein the message comprises:
a first information element indicating a first congestion control processing capability that constitutes the SL-PRS congestion control processing capability of the UE; and
a second information element indicating a second congestion control processing capability that constitutes a congestion control processing capability of the UE for congestion control of a second SL resource pool, the second SL resource pool not comprising SL-PRS resources.

16. The UE of claim 15, wherein the one or more processors are configured to determine, in accordance with the second congestion control processing capability, an applicable congestion control processing time value for congestion control of the second SL resource pool.

17. The UE of claim 12, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.

18. The UE of claim 17, wherein the one or more processors are configured to:
determine, in accordance with the common congestion control processing capability:
a first congestion control processing time value constituting the applicable congestion control processing time value for congestion control of the first SL resource pool; and
a second congestion control processing time value constituting an applicable congestion control processing time value for congestion control of the second SL resource pool.

19. The UE of claim 18, wherein the one or more processors are configured to modify the second congestion control processing time value according to one or more modification factors to determine the first congestion control processing time value.

20. The UE of claim 19, wherein the modifying the second congestion control processing time value according to the one or more modification factors includes scaling the second congestion control processing time value based on a ratio between a bandwidth of the first SL resource pool and a bandwidth of the second SL resource pool.

21. The UE of claim 12, wherein the message indicates a sidelink congestion control SL-PRS resource processing capability of the UE.

22. The UE of claim 12, wherein the message indicates an SL-PRS buffering capability of the UE.

23. An apparatus for wireless communication, comprising:
means for transmitting a message indicating a sidelink positioning reference signal (SL-PRS) congestion control processing capability of a user equipment (UE);
means for determining, in accordance with the SL-PRS congestion control processing capability of the UE, an applicable congestion control processing time value for congestion control of a first sidelink (SL) resource pool, the first SL resource pool comprising SL-PRS resources;
means for measuring a channel busy ratio (CBR) of the first SL resource pool for a first slot;
means for selecting, based on the measured CBR, a resource of the first SL resource pool for use to communicate during a second slot, wherein the second slot is offset in time from the first slot by the applicable congestion control processing time value; and
means for communicating using the selected resource during the second slot.

24. The apparatus of claim 23, wherein the applicable congestion control processing time value is determined based on a congestion control processing time value set corresponding to the SL-PRS congestion control processing capability of the UE.

25. A non-transitory computer-readable medium storing instructions for wireless communication by a user equipment (UE), the instructions comprising code for:
transmitting a message indicating a sidelink positioning reference signal (SL-PRS) congestion control processing capability of the UE;
determining, in accordance with the SL-PRS congestion control processing capability of the UE, an applicable congestion control processing time value for congestion control of a first sidelink (SL) resource pool, the first SL resource pool comprising SL-PRS resources;
measuring a channel busy ratio (CBR) of the first SL resource pool for a first slot;
selecting, based on the measured CBR, a resource of the first SL resource pool for use to communicate during a second slot, wherein the second slot is offset in time from the first slot by the applicable congestion control processing time value; and
communicating using the selected resource during the second slot.

26. The non-transitory computer-readable medium of claim 25, wherein the applicable congestion control processing time value is determined based on a congestion control processing time value set corresponding to the SL-PRS congestion control processing capability of the UE.

27. The non-transitory computer-readable medium of claim 26, the instructions comprising code for identifying a value in the congestion control processing time value set as the applicable congestion control processing time value based on a sub-carrier spacing of the first SL resource pool.

28. The non-transitory computer-readable medium of claim 25, wherein the message comprises:
a first information element indicating a first congestion control processing capability that constitutes the SL-PRS congestion control processing capability of the UE; and
a second information element indicating a second congestion control processing capability that constitutes a congestion control processing capability of the UE for congestion control of a second SL resource pool, the second SL resource pool not comprising SL-PRS resources.

29. The non-transitory computer-readable medium of claim 28, the instructions comprising code for determining, in accordance with the second congestion control processing capability, an applicable congestion control processing time value for congestion control of the second SL resource pool.

30. The non-transitory computer-readable medium of claim 25, wherein the message comprises an information element indicating a common congestion control processing capability that constitutes both the SL-PRS congestion control processing capability of the UE and a congestion control processing capability of the UE for congestion control of a second SL resource pool, the second SL resource pool not comprising SL-PRS resources.

31-35. (canceled)
